(19) United States
(12) Patent Application Publication
(10) Pub. No.: US 2007/0008296 A1
(43) Pub. Date: Jan. 11, 2007

(54) COMPUTER SYSTEM CAPABLE OF PREVENTING FROM LOSING A TOUCH PEN

(76) Inventor: Peng-Hui Chou, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/382,931

(22) Filed: May 12, 2006

(30) Foreign Application Priority Data
Jul. 11, 2005 (TW) 094123406

(51) Int. Cl. G09G 5/00

(52) U.S. Cl. 345/173

(57) ABSTRACT

A computer system includes a touch pen; a sensor for detecting whether the touch pen is at a predetermined position; and a controller electrically connected to the sensor for controlling an operation of a predetermined procedure according to a detecting result of the sensor in the predetermined procedure.

### BACKGROUND OF THE INVENTION

1. Field of the Invention

The invention relates to a computer system, and more particularly, to a computer system capable of preventing from losing a touch pen.

2. Description of the Prior Art

In today's information society, a variety of electronic products help people in their life. Especially, the cell phone, the personal digital assistance (PDA), and the laptop become more and more popular because of their characteristics of low weight, small volume, and convenience to carry.

As our technology continues to progress, the input devices utilizes with our electronic products are constantly improved. Because a traditional keyboard occupies a lot of space and definitely has a fixed weight, touch pens and touch screens are being utilized more often for the electronic products that are disclosed for providing a new selection of input devices to users. Therefore, the consumer can purchase a tablet personal computer, which has the touch pen and touch screen, instead of the traditional computer for saving more space and utilizing a new method to input data.

Please refer to FIG. 1, which is a diagram of a tablet personal computer 100 according to the prior art. As shown in FIG. 1, the tablet personal computer includes a touch screen 110, a body 120, and a touch pen 130. As mentioned previously, the touch screen 110 and the touch pen 130 can be the input device of the tablet personal computer 100. In other words, the data can be inputted into the tablet personal computer 100 through utilizing touch pen 130 to touch the touch screen 130. For example, the user can utilize the touch pen 130 to touch a certain icon in a window system in order to select a program to be executed such that the predetermined functions of the tablet personal computer 100 can be achieved.

Moreover, as known by those skilled in the art, the body 120 comprises main components of the tablet personal computer 100. For example, a CPU, a motherboard, memory, and disk drives (not shown) are all installed within the body 120. Surely, as shown in FIG. 1, a keyboard 140 can be placed above the body 120 in order to provide another selection for the user to input data.

Generally speaking, the touch pen 130 is normally placed in the pen seat (not shown). And the user removes the touch pen 130 from the pen seat when the touch pen 130 needs to be utilized. However, the user may forget to replace the touch pen 130 back to the pen seat, such that the touch pen 130 is missing from the pen seat. Apparently, the user has to spend money to purchase a replacement touch pen. This is not a good idea.

In order to prevent an incident of losing the touch pen 130, a band can be utilized to connect the touch pen 130 and the tablet personal computer 100. Although this method makes sense and is able to prevent an incident of losing the touch pen 130, it is definitely an ugly method. That is, the band may ruin the overall beauty of the otherwise aesthetically pleasingly designed tablet personal computer 100. Furthermore, the consumer may no longer appreciate the overall aesthetic of the electronic device because of the additional band. This may have a direct and negative influence on the selling of the electronic device.

### SUMMARY OF THE INVENTION

It is therefore one of the primary objectives of the claimed invention to provide a computer system capable of preventing an incident of losing a touch pen, to solve the above-mentioned problem.

According to an exemplary embodiment of the claimed invention, a computer system is disclosed. The computer system comprises: a touch pen; a sensor for detecting whether the touch pen is in a predetermined position; and a controller, electrically connected to the sensor, for controlling an operation of a predetermined procedure according to sensing results of the sensor in the predetermined procedure.

According to an exemplary embodiment of the claimed invention, a method for preventing from a touch pen of a computer system is disclosed. The method comprises: detecting whether the touch pen is in a predetermined position; and controlling an operation of a predetermined procedure according to a detecting result in the predetermined procedure.

The present invention tablet personal computer can remind the user to return the touch pen to the pen seat during the shutdown procedure. In addition, if the touch pen is not placed in the pen seat, the tablet personal computer may pause the shutdown procedure until the touch pen is replaced to the pen seat. Therefore, the present invention can prevent an incident of losing the touch pen due to the user's mistake. Furthermore, the touch pen is not required to be tied to the tablet personal computer through the band. In other words, the user does not need to pay for a replacement touch pen while simultaneously maintaining the beauty of the tablet personal computer.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a tablet personal computer according to the prior art.

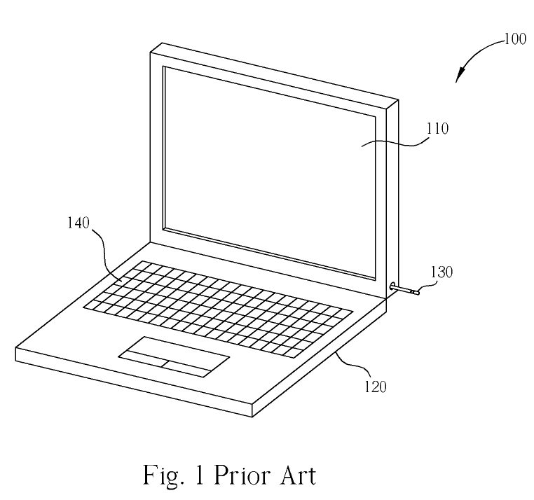

FIG. 2 is a diagram of a tablet personal computer according to one preferred embodiment of the present invention.

FIG. 3 is a block diagram of the tablet personal computer according to one preferred embodiment of the present invention.

FIG. 4 is a flow chart of an implementation of preventing from loosing the touch pen according to one preferred embodiment of the present invention.

### DETAILED DESCRIPTION

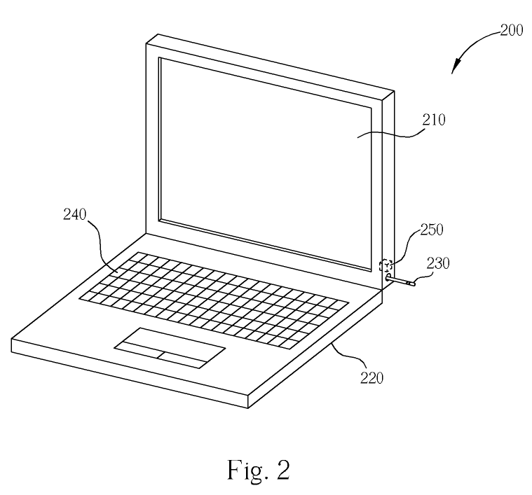

Please refer to FIG. 2, which is a diagram of a tablet personal computer 200 according to one preferred embodiment of the present invention. As shown in FIG. 2, the tablet personal computer includes a touch screen 210, a body 220, and a touch pen 230. Please note that the tablet personal computer 100 is similar to the aforementioned tablet personal computer 100 and the touch screen 210 and the touch pen 230 are the input devices of the tablet personal computer 200. In other words, the data can also be inputted into the tablet personal computer 200 through utilization of the touch pen 210 to touch the touch screen 210. Additionally, the body 220 includes main components (e.g., the CPU, motherboard, memory, and disk drives) of the tablet personal computer 200. Surely, as shown in FIG. 2, the body 220 can also include a keyboard 240 as a means for providing yet another selection for the user to input data.

The difference between the tablet personal computer 200 provided by the preferred embodiment of the present invention and the prior art computer 100 is that the tablet personal computer 200 further includes a sensor 250, which can be placed in the pen seat for detecting whether the touch pen 230 is in the pen seat such that the touch pen 230 can be detected for the purpose of preventing an incident of loosing the touch pen 230.

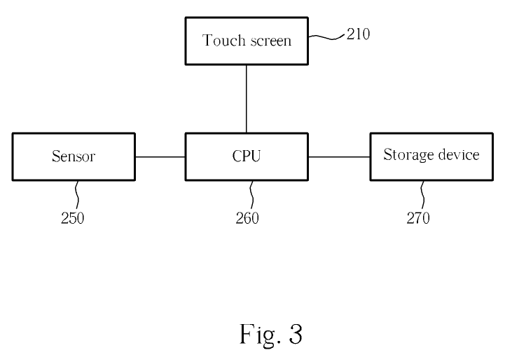

Surely, the preferred embodiment of the present invention does require some changes in software corresponding to the above-mentioned hardware mechanisms in order to further prevent the touch pen 230 from being lost. Here, please refer to FIG. 3, which is a block diagram of the tablet personal computer 200 according to the preferred embodiment of the present invention. As shown in FIG. 3, the tablet personal computer 200 includes a CPU 260, a storage device 270, the above-mentioned touch screen 210, and the sensor 250. It is well known that the storage device 270 can be a memory or a disk drive for storing a specific program code or data, and the CPU 260 can load the specific program code from the storage device and execute the loaded program code. Please note that the touch pen 230 and the keyboard 240 are not shown in FIG. 3 for simplicity.

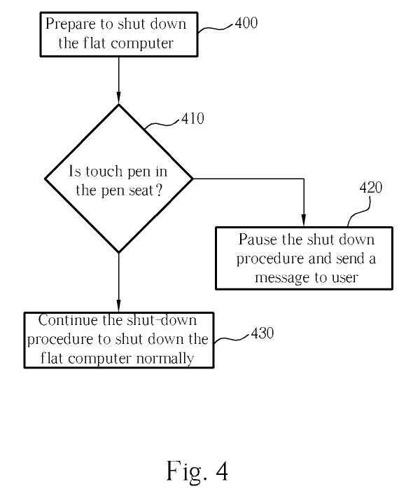

Please refer to FIG. 4, which is a flow chart of an implementation of preventing the touch pen 230 from being misplaced according to the preferred embodiment of the present invention.

First, after the user finishes utilizing the tablet personal computer 200, the user performs the shutdown operation on the tablet personal computer 200. That is, the user can choose to execute a shutdown command for the tablet personal computer 200, and the CPU 260 of the tablet personal computer 200 will then execute the shutdown program of an operation system (OS) to shut down the tablet personal computer 200 (step 400).

Therefore, the tablet personal computer 200 starts performing the shutdown procedure. Please note that the preferred embodiment CPU 260 of the tablet personal computer 200 further executes a program code stored in the storage device 270 to utilize the sensor 250 to detect whether the touch pen is placed in the pen seat (step 410). At this time, if the sensor 250 does not detect the touch pen 230, this means that the user did not replace the touch pen 230 to the pen seat. Therefore, the CPU 260 continues executing the program code, which will pause the shutdown procedure and display a warning message to the user in order to remind the user to replace the touch pen 230 to the pen seat (step 420).

In other words, because the preferred embodiment tablet personal computer 200 additionally executes a program code, the sensor 250 detects the touch pen 230 before the tablet personal computer 200 shuts down. In addition, if the touch pen 230 is not detected, the tablet personal computer 200 cannot shut down and will instead remind the user to replace the touch pen 230 to the pen seat. For example, the tablet personal computer 200 can show a message on the touch screen 210 that reads, “Please put the touch pen back into the pen seat.” Therefore, this can ensure that the user puts the touch pen 230 back when the touch pen 230 is utilized. As a result, the possibility of missing the touch pen 230 is decreased.

At last, when the touch pen 230 is replaced to the pen seat, the sensor 250 can detect the touch pen 230. Therefore, the CPU 260 can execute the shutdown procedure to shut down the tablet personal computer 200 normally (step 430). Please note that the program code can be easily written by those skilled in the art, and therefore the detailed illustration of writing the program code is thus omitted here.

Please note that in this embodiment, an examining procedure is added in a normal shutdown procedure to detect whether the touch pen 230 is placed in the pen seat. But the preferred embodiment does not limit the time of the examining procedure. That is, in the actual implementation, the examining procedure can be performed after many programs. For example, the examining procedure may be performed in a booting procedure. In other words, executing the examining procedure in the shutdown procedure is only utilized as a preferred embodiment, not a limitation of the present invention.

As mentioned previously, if the sensor 250 does not detect the touch pen 230 when the tablet personal computer 200 is in the shutdown procedure, the shutdown procedure is paused. However, the tablet personal computer 200 can also continue the shutdown procedure, but show the warning message to the user in order to provide nothing more than a reminder to the user. This change also obeys the spirit of the present invention.

Please note that the present invention can be utilized in other fields. For example, the present invention can be utilized in a cell phone having a touch pen, a PDA, and so on. The present invention is not limited to be utilized in the tablet personal computer. This change also obeys the spirit of the present invention.

In contrast to the prior art, the preferred embodiment tablet personal computer can remind the user to replace the touch pen to the pen seat in the shutdown procedure. In addition, if the touch pen is not placed in the pen seat, the tablet personal computer pauses the shutdown procedure until the touch pen is replaced to the pen seat. Therefore, the present invention can prevent an incident of losing the touch pen due to the user's mistake. Furthermore, it is not required that the touch pen be tied to the tablet personal computer through the use of a band. In other words, the user does not need to pay for another touch pen, and can maintain the overall beauty of the tablet personal computer.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A computer system comprising:
a touch pen;
a sensor for detecting whether the touch pen is in a predetermined position; and
a controller, electrically connected to the sensor, for controlling an operation of a predetermined procedure according to sensing results of the sensor in the predetermined procedure.

2. The computer system of claim 1, wherein if the sensor does not detect the touch pen, the controller outputs a warning message.

3. The computer system of claim 1, wherein the controller is a central processing unit (CPU), the computer system further comprises: a storage device, electrically connected to the CPU for storing a program code, and the CPU executes the program code in the predetermined procedure to control the operation of the predetermined procedure according to the sensing result of the sensor.

4. The computer system of claim 3, wherein the predetermined procedure is a shutdown procedure, and if the sensor does not detect the touch pen in the predetermined position, the CPU executes the program code to pause the shutdown procedure.

5. The computer system of claim 1, wherein the computer system is a laptop system or a tablet personal computer system.

6. A method for preventing from a touch pen of a computer system, the method comprising:
detecting whether the touch pen is in a predetermined position; and
controlling an operation of a predetermined procedure according to a detecting result in the predetermined procedure.

7. The method of claim 6, wherein the step of controlling a operation of a predetermined procedure according to a detecting result in the predetermined procedure further comprises:
if the touch pen is not detected in the predetermined position, outputting a warning message.

8. The method of claim 6, wherein the predetermined procedure is a shutdown procedure, and the step of controlling an operation of a predetermined procedure according to a detecting result in the predetermined procedure further comprising:
if the touch pen is not detected in the predetermined position, pausing the shutdown procedure.

9. The method of claim 6, wherein the computer system is a laptop system or a tablet personal computer system.
